(19) United States
(12) Patent Application Publication
(10) Pub. No.: US 2024/0337352 A1
(43) Pub. Date: Oct. 10, 2024

(54) INSULATION SECUREMENT SYSTEM AND ASSOCIATED METHODS

(71) Applicant: MARATHON PETROLEUM COMPANY LP, Findlay, OH (US)

(72) Inventors: Jon Craig, Findlay, OH (US); Michael Basic, Findlay, OH (US)

(21) Appl. No.: 18/679,385

(22) Filed: May 30, 2024

Related U.S. Application Data
(63) Continuation of application No. 16/828,723, filed on Mar. 24, 2020, now Pat. No. 12,031,676.
(60) Provisional application No. 62/823,156, filed on Mar. 25, 2019.

(51) Int. Cl. F17C 1/12; G21C 11/08; G21C 13/02

(52) U.S. Cl. CPC F17C 1/12; B01J 2219/00155; G21C 11/08; G21C 13/02; Y02E 30/30

(57) ABSTRACT

Systems and methods for insulating vessels are disclosed. In one or more embodiments, the disclosure provides a vessel insulation system (e.g., for use with a reactor or pressure vessel), which includes a floating ring sized to circumscribe a top nozzle of a vessel; a plurality of straps connected to the floating ring, the plurality of straps extending downward from the floating ring and being positioned to run along a length of the outer shell of the vessel; and a plurality of segmented rings positioned to circumscribe the outer shell of the vessel and connected to the plurality of straps. The plurality of segmented rings is configured to support an insulation material circumscribing the outer shell of the vessel, which can provide effective securement of the insulation material around the outer shell without welding components on the vessel to secure the insulation material.

### CROSS-REFERENCE TO RELATED APPLICATION

This application is a continuation of U.S. Non-Provisional application Ser. No. 16/828,723, filed Mar. 24, 2020, titled “INSULATION SECUREMENT SYSTEM AND ASSOCIATED METHODS,” which claims priority to and the benefit of U.S. Provisional Application No. 62/823,156, filed Mar. 25, 2019, titled “FLOATING RING VESSEL INSULATION SUSPENSION METHOD AND APPARATUS,” the disclosures of which are incorporated herein by reference in their entireties.

### FIELD OF THE DISCLOSURE

The disclosure herein relates to systems and methods for insulating reactor and/or pressure vessels, such as catalytic reactors, and one or more embodiments of an apparatus and methods suitable for use in supporting and securing insulation materials to such vessels.

### BACKGROUND

Reactor vessels and pressure vessels are used for various applications in research, development, and production. The size and shape of such vessels can vary widely, but certain features are consistent among most vessels. The outer shells of reactor and pressure vessels are typically welded at various positions during construction/formation of the vessels. For example, since reactor vessels are typically very large, various sections of material forming the outer shell must be individually welded together during construction of the vessel. The materials used for producing such outer shells (e.g., metals and alloys) often require post-weld heat treatment (PWHT) to relieve residual stress associated with the shell after welding. PWHT can serve to reduce stress associated with weldments down to acceptable levels approximating the adjacent base metal capabilities, but such treatment generally reduces the strength of the material at/around the site at which PWHT is applied.

Reactor vessels and pressure vessels may be insulated to ensure thermal continuity within the vessel (and throughout the contents of the vessel). As will be referenced further herein below, the weight associated with insulation materials can be substantial, particularly with respect to reactors of significant height. Common industry practice for installation of insulation materials on reactor vessels is to weld brackets or lugs to the vessel shell to support the vertical weight of the insulation materials when installed thereon. The welding of such brackets/lugs onto vessel shells is quite expensive (e.g., due to high energy costs and maintenance-related delays) as the entire reactor vessel must be subjected to an additional PWHT process following the welding. Such PWHT process relieves residual welding stress from the vessel prior to installing the insulation material and placing the reactor vessel into operation. Some alternative insulation methods use tightly banded straps around the vessel shell to hold layers of insulation in place mechanically via friction. Such friction methods for banding insulation to vessels without brackets typically do not hold up well over time. Therefore, even these friction methods commonly utilize brackets that are installed by welding as part of shop fabrication or installation in the field. In either event, further PWHT is generally necessary to relieve residual stress in the reactor vessel that is caused due to the welding treatment used to secure the brackets or lugs to the vessel shell, which support the insulation material. As noted above, PWHT commonly reduces the strength of the material at and around the treatment site. Further, PWHT can negatively impact vessels made of materials that are susceptible to cracking. For instance, potential detrimental effects of PWHT include reactor distortion, temper embrittlement, over-softening, reheat cracking, and the like.

Certain industry practices do not require PWHT; such approaches include using a friction banding method with multiple banded straps (e.g., such as ratchet tightening straps) positioned at different points vertically along the exterior of the reactor vessel that can be tightened to hold the insulation layers in place via friction. Example banding systems for use with insulation applications, as will be understood by those skilled in the art, are described in U.S. Pat. No. 9,068,582 to Wolbert et al. However, such a banding approach (without further securement, e.g., via welding) suffers from various drawbacks. For example, the life span of such insulation configurations is shorter than configurations employing welding and the banded straps are particularly susceptible to sagging over time as the reactor vessel circumferentially expands and contracts during use. Further, such configurations are less effective for sealing out moisture and protecting the insulation from deterioration due to exposure to moisture.

Therefore, it would be advantageous to develop methods and systems for insulating reactor/pressure vessels that minimize the amount of welding required to secure insulation, and thus reduce the amount of post-weld heat treatment.

### SUMMARY OF THE DISCLOSURE

The disclosure herein provides one or more embodiments of systems and methods to secure insulation, e.g., on the vessel shell of a reactor vessel or pressure vessel. Such systems and methods advantageously do not rely on welding and thus can eliminate the need for PWHT of the vessel for insulation securement. These systems and methods can provide for extended lifespan of the vessel and can further offer resistance to deterioration of the insulation as a result of sagging, water penetration, and/or other external factors or contaminants.

In one aspect, the disclosure provides a vessel insulation system comprising a floating ring sized to circumscribe a top nozzle (e.g., a discharge nozzle) of a vessel (e.g., a reactor vessel or a pressure vessel), a plurality of straps connected to the floating ring, the plurality of straps extending downward from the floating ring and being positioned to run along a length of the outer shell of the vessel; a plurality of segmented rings positioned to circumscribe the outer shell of the vessel and connected to the plurality of straps, wherein the plurality of segmented rings is configured to support an insulation material circumscribing the outer shell of the vessel. In a further aspect, the disclosure provides a vessel insulation system, comprising: a floating ring circumscribing a top nozzle of a vessel; a plurality of straps connected to the floating ring that extend downward from the floating ring a length along an outer shell of the vessel; and a plurality of segmented rings for circumscribing the outer shell of the vessel and connected to the plurality of straps, wherein the plurality of segmented rings is configured to support an insulation material circumscribing the outer shell of the vessel. A further aspect of the disclosure provides an insulated vessel, comprising a vessel, an insulation material, and a vessel insulation system as described herein. In various embodiments provided herein, the vessel is a reactor vessel or a pressure vessel.

In some embodiments, the floating ring, the plurality of straps, and the plurality of segmented rings independently comprise a material selected from the group consisting of metals, metal alloys, or any combination thereof. In some embodiments, the floating ring, the plurality of straps, and the plurality of segmented rings comprise a stainless steel material. In some embodiments, the plurality of straps is substantially perpendicular to the plurality of segmented rings. In some embodiments, the floating ring, the plurality of straps, and the plurality of segmented rings have not been welded to the outer shell of the vessel. In some embodiments, the plurality of segmented rings is supported by the plurality of straps. In some embodiments, the insulation material is a plurality of insulation segments, each insulation segment being individually supported by a corresponding segment of the plurality of segmented rings. In some embodiments, each insulation segment is configured to be individually removable and/or replaceable, without disturbing any of the remaining insulation segments.

In some embodiments, the insulation material comprises a first layer of insulation, a second layer of insulation, and an outer jacket surrounding the first and second insulation layers. In some embodiments, the outer jacket comprises a corrugated metal jacketing material and a plurality of springs. In some embodiments, the vessel insulation system may further comprise a skirt portion positioned proximate a base portion of the vessel. In some embodiments, the skirt portion comprises a plurality of springs connected to the plurality of straps, and wherein the plurality of springs is configured to allow for vertical expansion of the vessel insulation system during operation of the vessel.

Some aspects of the disclosure provide methods of insulating vessels (e.g., reactor vessels or pressure vessels). For instance, such methods may comprise installing an embodiment of the vessel insulation system disclosed herein and installing one or more layers of an insulation material circumscribing an outer shell of the vessel. In some embodiments, the method of insulating a vessel may further comprise installing an outer jacket surrounding the one or more layers of insulation material. In some embodiments, the one or more layers of insulation material are installed in individual insulation segments. In some embodiments, each insulation segment is configured to be individually removable and/or replaceable, without disturbing any of the remaining insulation segments.

In some embodiments, a method of insulating a vessel without welding any insulation support structure to the vessel is disclosed. In such embodiments, for example, the method may comprise: (i) positioning a floating ring proximate to and circumscribing a top nozzle of a vessel, (ii) attaching a plurality of straps to the floating ring extending downward from the floating ring a length along an outer shell of the vessel, (iii) selectively positioning a plurality of segmented rings along the length of the outer shell, wherein the segmented rings are attached to and supported by the plurality of straps, and (iv) installing an insulation material that circumscribes the outer shell of the vessel, the insulation material being supported by the segmented rings. In some embodiments, the method may further comprise installing the insulation material in individual insulation segments. In some embodiments, none of the above method steps (i)-(iii) comprise welding any material to the outer shell of the vessel.

Other aspects of the disclosure are directed to a method of maintenance and repair of an insulated vessel. In one such embodiment, the method includes providing a vessel having an embodiment of the vessel insulation system disclosed herein and selectively removing and replacing individual insulation segments based on a pre-determined level of deterioration without disturbing any of the remaining insulation segments.

The disclosure thus includes, without limitation, the following embodiments:

A vessel insulation system, comprising: a floating ring sized to circumscribe a top nozzle of a vessel; a plurality of straps connected to the floating ring, the plurality of straps extending downward from the floating ring and being positioned to run along a length of the outer shell of the vessel; and a plurality of segmented rings positioned to circumscribe the outer shell of the vessel and connected to the plurality of straps, wherein the plurality of segmented rings is configured to support an insulation material circumscribing the outer shell of the vessel.

A vessel insulation system as disclosed above, wherein the floating ring, the plurality of straps, and the plurality of segmented rings each independently comprise a material selected from the group consisting of metals, metal alloys, or any combination thereof.

A vessel insulation system as disclosed above, wherein the floating ring, the plurality of straps, and the plurality of segmented rings each comprise a stainless steel material.

A vessel insulation system as disclosed above, wherein the plurality of straps is substantially perpendicular to the plurality of segmented rings.

A vessel insulation system as disclosed above, wherein the floating ring, the plurality of straps, and the plurality of segmented rings have not been welded to the outer shell of the vessel.

A vessel insulation system as disclosed above, wherein the plurality of segmented rings is supported by the plurality of straps.

An insulated vessel, comprising: a reactor vessel; an insulation material; and the reactor vessel insulation system as disclosed above.

An insulated vessel as disclosed above, wherein the insulation material is a plurality of insulation segments, each insulation segment being individually supported by a corresponding segment of the plurality of segmented rings.

An insulated vessel as disclosed above, wherein each insulation segment is configured to be individually removable and/or replaceable, without disturbing any of the remaining insulation segments.

An insulated vessel as disclosed above, wherein the insulation material comprises a first layer of insulation, a second layer of insulation, and an outer jacket surrounding the first and second insulation layers.

An insulated vessel as disclosed above, wherein the outer jacket comprises a corrugated metal jacketing material and a plurality of springs.

An insulated vessel as disclosed above, further comprising a skirt portion positioned proximate a base portion of the vessel.

An insulated vessel as disclosed above, wherein the skirt portion comprises a plurality of springs connected to the plurality of straps, and wherein the plurality of springs is configured to allow for vertical expansion of the vessel insulation system during operation.

A method of insulating a vessel, the method comprising:
providing a vessel and the vessel insulation system as disclosed above; and installing one or more layers of an insulation material circumscribing an outer shell of the vessel.

A method of insulating a vessel as disclosed above, further comprising installing an outer jacket surrounding the one or more layers of insulation material.

A method of insulating a vessel as disclosed above, wherein the one or more layers of insulation material are installed in individual insulation segments.

A method of insulating a vessel as disclosed above, wherein each insulation segment is configured to be individually removable and/or replaceable, without disturbing any of the remaining insulation segments.

A method of insulating a vessel without welding any insulation support structure to the vessel, the method comprising: (i) positioning a floating ring proximate to and circumscribing a top nozzle of a vessel; (ii) attaching a plurality of straps to the floating ring extending downward from the floating ring a length along an outer shell of the vessel; (iii) selectively positioning a plurality of segmented rings along the length of the outer shell, wherein the segmented rings are attached to and supported by the plurality of straps; and (iv) installing an insulation material that circumscribes the outer shell of the vessel, the insulation material being supported by the segmented rings.

A method of insulating a vessel without welding to the vessel as disclosed above, further comprising installing the insulation material in individual insulation segments.

A method of insulating a vessel without welding to the vessel as disclosed above, wherein none of steps (i)-(iii) comprise welding any material to the outer shell of the vessel.

A method of maintenance and repair of an insulated vessel, the method comprising: providing an insulated vessel as disclosed above, and selectively removing and replacing individual insulation segments based on a pre-determined level of deterioration without disturbing any of the remaining insulation segments.

These and other features, aspects, and advantages of the disclosure will be apparent from a reading of the following detailed description together with the accompanying drawings, which are briefly described below. The disclosure includes any combination of two, three, four, or more features or elements set forth in this disclosure or recited in any one or more of the claims, regardless of whether such features or elements are expressly combined or otherwise recited in a specific embodiment description or claim herein. This disclosure is intended to be read holistically such that any separable features or elements of the disclosure, in any of its aspects and embodiments, should be viewed as intended to be combinable, unless the context of the disclosure clearly dictates otherwise.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates a perspective view of a horizontally-positioned reactor vessel having a reactor vessel insulation system comprising a floating ring circumscribing a top nozzle of the reactor vessel, a plurality of straps attached to the floating ring, and a plurality of segmented rings attached to the straps, installed thereon according to an embodiment of the disclosure;

FIG. 2 illustrates a two-dimensional view of the top of a reactor vessel having a reactor vessel insulation system installed thereon, according to an embodiment of the disclosure;

FIG. 3 shows a cut-away view of detail A as shown in FIG. 2, wherein detail A illustrates the physical connection between one of a plurality of straps and a floating ring, according to an embodiment of the disclosure;

FIG. 4 shows a cut-away view of detail B as shown in FIG. 2, wherein detail B illustrates the physical connection between one of a plurality of straps and one of a plurality of segmented rings, according to an embodiment of the disclosure;

FIG. 5 illustrates a reactor vessel insulation system that is fully installed on a vertical reactor vessel including a first layer of insulation material and a skirt portion attached to a base portion of the reactor vessel, according to an embodiment of the disclosure;

FIG. 6 shows a cut-away view of detail C as shown in FIG. 5, wherein detail C illustrates the physical connection between one of a plurality of straps and a flange attached to a base portion of the reactor vessel, according to an embodiment of the disclosure;

FIG. 7 shows a cut-away view of detail C in one or more embodiments where the reactor vessel insulation system further comprises a second floating ring positioned at the base portion of the reactor vessel, wherein detail C illustrates the physical connection between one of a second plurality of straps and a second flange attached to a base portion of the reactor vessel, according to an embodiment of the disclosure;

FIG. 8 illustrates a reactor vessel insulation assembly that is fully installed on a vertical reactor vessel including a second layer of insulation material, according to an embodiment of the disclosure;

FIG. 9 illustrates an outer jacket surrounding a first layer of insulation material and a second layer of insulation material, according to an embodiment of the disclosure;

FIG. 10 shows a close up cross-sectional view of a first layer of insulation material, a second layer of insulation material, and an outer jacket surrounding the first and second layers of insulation material being supported by a reactor vessel insulation system according to an embodiment of the disclosure; and

FIG. 11 illustrates a perspective view of the horizontally-positioned reactor vessel and the reactor vessel insulation system as depicted in FIG. 1, wherein the reactor vessel and the reactor vessel insulation system have been completely encased by one or more layers of insulation material and an outer jacket, according to an embodiment of the disclosure.

### DETAILED DESCRIPTION OF THE DISCLOSURE

The disclosure now will be described more fully hereinafter with reference to specific embodiments and particularly to the various drawings provided herewith. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a,” “an,” “the,” include plural referents unless the context clearly dictates otherwise.

The disclosure provides materials and methods suitable for use in insulating vessels (e.g., including, but not limited to, pressurized vessels, reactor vessels, and catalytic reactor vessels). In particular, as will be provided in further detail herein below, the materials and methods relate to an insulation securement system (referred to herein also as an “insulation system” and/or a “reactor vessel insulation system”) that does not require any welding to secure insulation to the shell of a vessel. Such an approach is advantageous, because minimizing the amount of welding to the exterior of a reactor vessel shell (and thus minimizing the subsequent PWHT applied thereto), can reduce potential damage to the outer shell of the vessel and provide efficiency and cost savings.

The types of catalytic reactors for which one or more embodiments of the disclosed insulation systems are relevant may vary and generally may include any type of vessels that are advantageously insulated. Various embodiments of the reactor vessel insulation systems according to the disclosure will be discussed herein in more detail regarding their specific application to gasoil hydrotreater (GOHT) catalytic reactor vessels, which is discussed by way of example only and is not meant to be construed as limiting with respect to the particular application of the disclosed embodiments of the systems and methods herein.

As is known in the art, vessels such as catalytic reactor vessels may be formed of various types of metals and/or metal alloys. For instance, traditional reactor vessels are commonly formed of carbon steel materials. Generally, these reactor vessels, as constructed, have been pre-treated to relieve stress imparted on the metal and/or metal alloy materials used in forming the reactor vessel. The sizes and shapes of vessels can vary widely, e.g., from small-scale, laboratory-based systems to very large, industrial vessels. In some embodiments, vessels for which the disclosed materials and methods are applicable can have heights, e.g., of at least about 100 feet, at least about 125 feet, at least about 150 feet, or at least about 175 feet.

Reactor vessels typically must be insulated in order to minimize heat loss and maintain thermal conductivity within the reactor vessel during use. The types of insulation materials used for this purpose can vary and typically include, but are not limited to, inorganic insulation materials (e.g., fibrous materials, such as mineral wool, glass wool, rock wool, and glass fiber felts; cellular materials, such as calcium silicate and cellular glass; and the like), organic insulation materials (e.g., petrochemical materials, such as expanded polystyrene (EPS), extruded polystyrene (XPS), polyurethane (PUR), phenolic foam, and polisocyanurate foam (PIR); renewable materials, such as cellulose, cork, wood fiber, hemp fiber, flax wool, sheep wool, and cotton insulation; and the like), and various other insulation materials (e.g., such as aerogels, vacuum panels, metallic foils, and/or reflective metallic insulation (RMI)). Such types of insulation materials may be used in various combinations, layers, and amounts as typically known in the art. For example, high temperature industrial insulation materials are commercially available from Aspen Aerogels, Inc.™ (see, e.g., Pyrogel HPS, Pyrogel XTE, and Pyrogel XTF insulation materials). According to the present disclosure, the types of insulation secured by the system provided herein are not particularly limited and include all materials that might be used for this purpose.

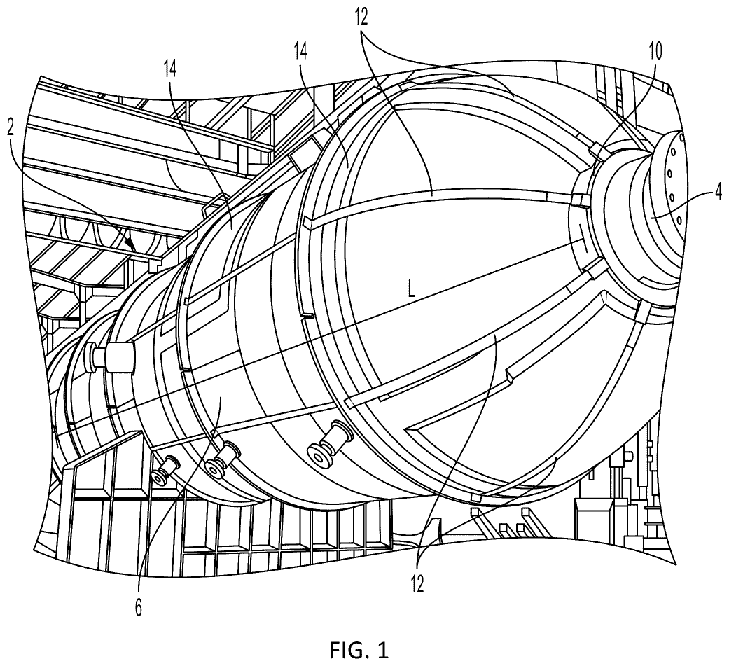

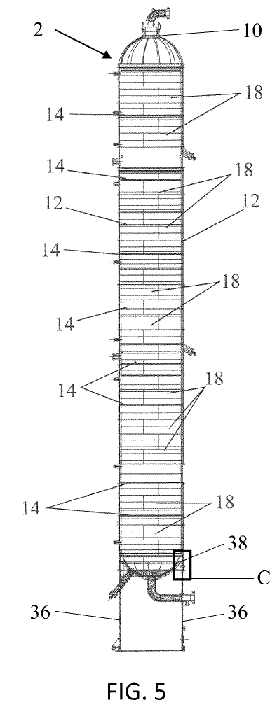

As depicted in FIG. 1, one embodiment of a vessel insulation system according to the disclosure comprises a floating ring 10 circumscribing a top nozzle 4 of a reactor vessel 2 and a plurality of straps 12 connected or attached to floating ring 10, which extend along a length L of an outer shell 6 of the reactor vessel 2. A plurality of segmented rings 14 circumscribe the outer shell 6 and connected or attached to the plurality of straps 12, wherein the plurality of segmented rings 14 is configured to support an insulation material circumscribing the outer shell 6 of the reactor vessel 2. It should be noted that the reactor vessel and the reactor vessel insulation system are depicted in a horizontal configuration as presented in FIG. 1; however, the reactor vessel, and likewise the reactor vessel insulation system, is typically in an upright, vertical configuration during use (e.g., as depicted in FIGS. 5-9 and as detailed further herein), such that the reactor vessel insulation system essentially hangs from the top of the reactor vessel via the floating ring (e.g., like a bird cage or an umbrella-type configuration) and substantially surrounds at least a portion of the outer shell of the reactor vessel.

A “floating ring” as used herein is a ring (typically constructed of metal, but not limited thereto), circumscribing a component at the top of the reactor, e.g., a discharge nozzle (as shown in FIG. 1). The floating ring may be in contact with the outer shell of the vessel, but it is not otherwise connected or attached to the outer surface of reactor vessel in any form other than via physical contact (e.g., it is not attached mechanically via welding, heat treating, clamping, etc.). Generally, the term “floating” as used in the industry can be used in reference to a floating ring bearing, a floating disc, and the like. Such terminology generally indicates that the ring material circumscribes some other component and may, or may not, necessarily come into physical contact with that other component. In vehicle applications using floating ring bearings, for example, a fluid barrier or pressurized air might come at least partially between the floating ring bearing and a cylindrical shaft such that at certain points, the floating ring bearing may contact the shaft, whereas at other points along the inner circumference of the floating ring bearing, the floating ring bearing may not contact the shaft. Likewise, it should be noted that a “floating ring” as used herein may or may not be in contact, fully or partially, with the outer shell of the reactor vessel at various times during operation of the reactor vessel. The floating ring may be constructed of a variety of different materials, for example, metals and/or alloys of metal. In some embodiments, the floating ring may be formed of a stainless steel material in particular. In some embodiments, for example, the floating ring may be formed of a stainless steel material such as S.S. TP 304. Relevant standards and specifications for such materials (and certain other materials referenced herein) are provided in ASTM A312 TP 304/304L (Standard Specifications for Stainless Steel Seamless Pipes and Tubes). The type and/or grade of stainless steel material may vary and such materials are commercially available from suppliers, such as, e.g., U.S. Metals, Inc.

A “plurality of straps” as used herein, refers to two or more elongated straps that are designed to extend along at least a portion of the length of the outer shell of the reactor vessel. In some embodiments, a plurality of straps may refer to at least 3 straps, at least 4 straps, at least 5 straps, at least 6 straps, at least 7 straps, at least 8 straps, or more. Generally, the length of the plurality of straps may be sized to extend at least a majority of the length of the reactor vessel (so as to extend a substantial portion of the length of the reactor, including embodiments wherein the straps extend the full length of the reactor, although not limited thereto). Typically, all straps are substantially the same length. The plurality of straps may be constructed of a variety of different materials, for example, metals and/or alloys of metal. In some embodiments, for example, the plurality of straps may be formed of a stainless steel material, e.g., such as SA 240 TP 304. Again, relevant standards and specifications for such materials are provided in ASTM A240 TP 304/304L (Standard Specifications for Stainless Steel Sheets and Plates). The type and/or grade of stainless steel material may vary and such materials are commercially available from suppliers, such as, e.g., U.S. Metals, Inc. The straps typically comprise the same material as one another, although the system is not limited thereto, and one strap may comprise a different material than another.

A “plurality of segmented rings” as used herein, refers to two or more rings (typically substantially circular rings) that are at least partially disconnected or detached at various points along the circumference of each ring, forming discrete segments in each ring. The discrete segments are connected or attached perpendicular or nearly perpendicular to the straps to form the segmented rings, which are circumferentially positioned around the vessel. Thus, the rings are typically positioned horizontally (with respect to the plurality of straps, which are described as being positioned “vertically”). Again, it is understood that such references are relevant to configurations wherein the vessel is upright, rather than on its side (as shown in FIG. 1). In some embodiments, the plurality of segmented rings may refer to at least 3 segmented rings, at least 4 segmented rings, at least 5 segmented rings, at least 6 segmented rings, at least 7 segmented rings, at least 8 segmented rings or more. In some embodiments, the number of discrete segments in each individual segmented ring may vary, for example, each segmented ring may comprise at least 2 discrete segments, at least 4 discrete segments, at least 6 discrete segments, at least 8 discrete segments, or more that are at least partially detached from each other, but that are connected or attached to the straps to form a segmented ring circumscribing the vessel. Generally, the diameter of the segmented rings may be sized appropriately based on the diameter of the reactor vessel. Typically, where the vessel has substantially the same diameter along its length, the segmented rings can have substantially the same diameter as one another (sufficient to circumscribe the exterior shell of the vessel). However, depending at least in part upon the construction/shape of the reactor and the longitudinal placement of the rings along the vessel, the diameters of the rings may vary from one another in order to accommodate the varying circumference of the vessel along its longitudinal axis. The plurality of segmented rings may be constructed of a variety of different materials, for example, metals and/or alloys of metal. In some embodiments, for example, the plurality of segmented rings may be formed of a stainless steel material, e.g., such as SA 516 GR.70N. Relevant standards and specifications for such materials are provided in ASTM A516 GR.70N (Standard Specifications for Steel Plates). The type and/or grade of stainless steel material may vary and such materials are commercially available from suppliers, such as, e.g., U.S. Metals, Inc. The rings typically comprise the same material as one another, although the system is not limited thereto, and one ring may comprise a different material than another in some embodiments as will be understood by those skilled in the art.

An insulation system as provided herein generally has at least two such segmented rings (as noted above) circumscribing the vessel, at various positions along the length thereof. Typically, it includes significantly more than two. In some embodiments, for example, the insulation system may comprise at least 4 segmented rings, at least 8 segmented rings, at least 12 segmented rings, at least 16 segmented rings, at least 20 segmented rings, at least 24 segmented rings, or more (e.g., such as about 4 to about 40 individual segmented rings, about 6 to about 20 individual segmented rings, or about 8 to about 12 individual segmented rings). Generally, the number of segmented rings provided in the insulation system may vary based on the particular height of the insulation vessel (e.g., the taller the vessel, the more segmented rings generally required) and the operating temperature of the vessel (e.g., the higher the temperature of the vessel, the more segmented rings generally required, e.g., in order to maintain outer jacketing screws in place). The number of segmented rings provided in the insulation system may further vary based on the weight of the particular type of insulation material being used, the standard size of the insulation material being installed thereon, the number of exterior components on the reactor vessel requiring clearance (e.g., exterior valves and/or piping that cannot be covered or completely encased by the insulation materials), and combinations thereof. In general, the overall configuration of the segmented rings positioned along the longitudinal axis or length of the reactor vessel (e.g., including the number and the characteristics thereof) can be adjusted to accommodate any size or type of reactor vessel and/or to support any size or type of insulation material connected or attached thereto, such as those described herein above. In some embodiments, the number of segmented rings may be adjusted to allow for a maximum level of expansion of the vessel so as to allow for expansion and/or contraction of the vessel. For example, in some embodiments, the number of segmented rings is configured to allow for a maximum level of expansion of less than about 0.5 inches over a 15-ft span, less than about 0.35 inches over a 15-ft span, or less than about 0.25 inches over a 15-ft span. Where the system comprises an outer jacket (as will be described in further detail herein below), the number of segmented rings can, in some embodiments, be selected such that screws in the outer jacket will not be pulled apart with expansion associated with temperature cycles.

In some embodiments, for example, the number of segmented rings positioned circumferentially about the vessel along its longitudinal axis may be affected by the specific load capacity of each individual segmented ring and/or the load capacity of each individual segment within those segmented rings. In some embodiments, one or more dimensions (e.g., such as the width) of the segmented rings may be altered so as to increase the load capacity of those rings. Typically, each of the segmented rings have substantially the same dimensions and/or substantially the same load capacity. However, such a configuration is not meant to be limiting and generally any and/or all of the individual segmented rings may have different dimensions and/or load capacities. In some embodiments, each individual segmented ring may be configured to support at least 100 lbs of insulation material, at least 1,000 lbs of insulation material, at least 10,000 lbs of insulation material, or more weight of insulation material. In some embodiments, the plurality of segmented rings may be evenly or non-evenly spaced circumferentially along the longitudinal axis or length of the reactor vessel. In some embodiments, the plurality of segmented rings may be closely spaced apart, for example, such that none of the individual rings are more than 20 feet apart, more than 15 feet apart, more than 10 feet apart, or more than 5 feet apart. In other words, the plurality of segmented rings may be closely spaced apart from each other such that each ring is less than 5 feet apart, less than 10 feet apart, less than 15 feet apart or even less than 20 feet apart. In some embodiments, the plurality of segmented rings may be widely spaced apart, for example, such that substantially all of the individual rings are spaced at least 20 feet apart, at least 25 feet apart, at least 30 feet apart, at least 35 feet apart, or at least 40 feet apart.

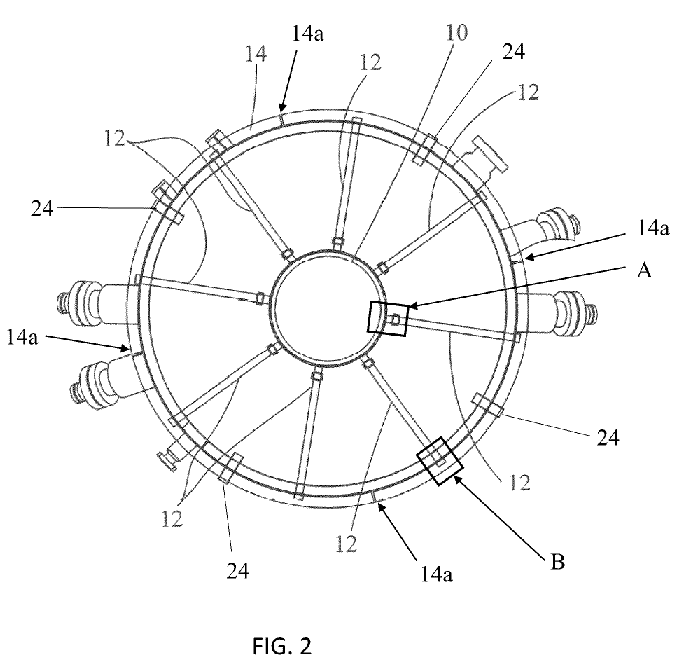

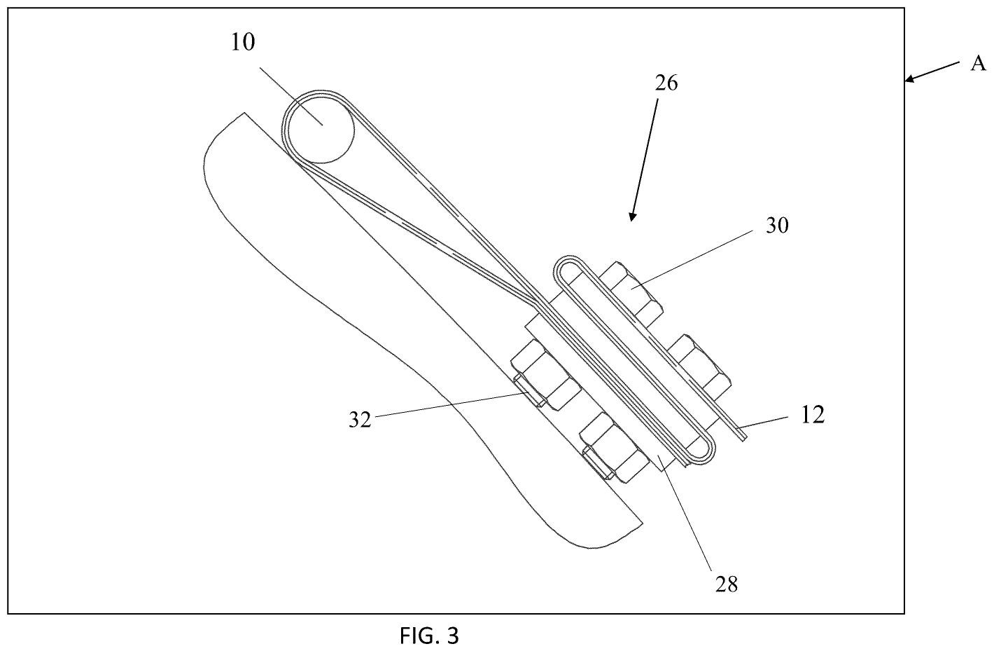

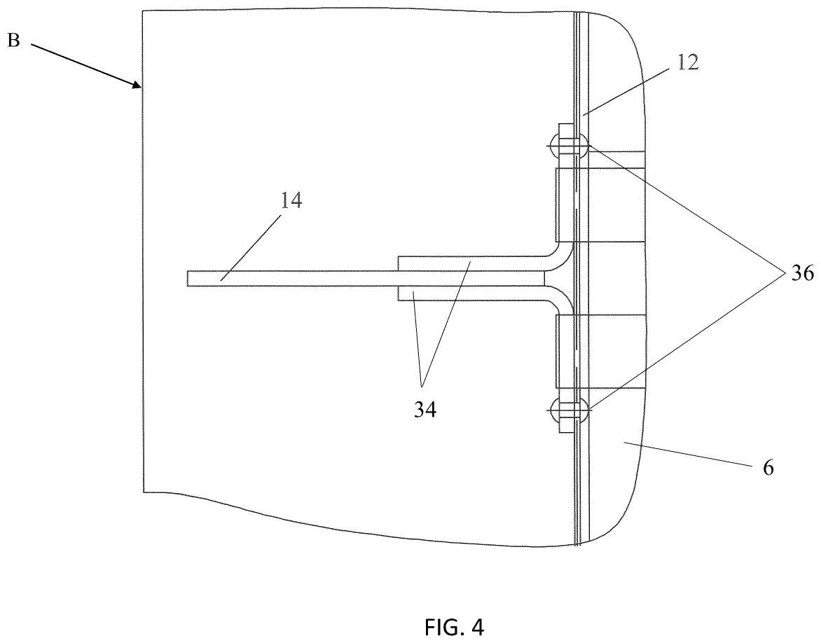

FIG. 2 depicts a two-dimensional view looking down from above at the top of the reactor vessel equipped with an insulation system according to an embodiment of the disclosure. In the embodiment depicted in FIG. 2, the floating ring 10 is connected or attached to the plurality of straps 12 as highlighted by detail A (which will be described in more detail in relation to FIG. 3) and the plurality of straps 12 is connected or attached to the plurality of segmented rings 14 as highlighted by detail B (which will be described in more detail in relation to FIG. 4). As noted above, each segmented ring may comprise any number of discrete segments therein that are at least partially detached from each other. For example, the detachment and/or disconnection point 14a of these discrete segments, either fully or partially, is depicted in FIG. 2. In some embodiments, the segmented rings may comprise one or more intermediate supports 24 connected or attached to the segmented rings 14 that provide, e.g., added strength and/or durability to the segmented rings. The number and/or positioning of these intermediate supports 24 may be varied, for example, based on the size of the reactor vessel, the type of insulation being used, and the like.

As noted above, the plurality of straps is generally physically connected or attached to the floating ring. The mechanism for connecting or attaching the plurality of straps may vary and generally may include any mechanism configured to maintain a secure connection or attachment between the floating ring and the plurality of straps before and during use of the reactor vessel. For example, FIG. 3 illustrates the physical connection or attachment of the plurality of straps and the floating ring according to an example embodiment of the present disclosure. As shown in FIG. 3, one of the plurality of straps 12 may be connected or attached to the floating ring 10 (a cross-sectional view of the floating ring 10 is depicted in FIG. 3) via a clamping mechanism 26. In some embodiments, the clamping mechanism 26 may comprise one or more clamping plates 28 that can be tightened by nut 30 and bolt 32 configurations. In some embodiments, the straps 12 may be doubled-over and/or folded within the clamping plates 28 prior to tightening in order to ensure a secure and permanent connection or attachment between the plurality of straps 12 and the floating ring 10, suitable for supporting the segmented rings (not shown) that are connected or attached thereto.

As noted above, the plurality of segmented rings 14 may be connected or attached to, and supported by the plurality of straps 12 at varying positions along the length of the straps 12. Generally, the plurality of straps 12 may be substantially parallel to the outer shell of the reactor vessel (e.g., such that the straps hang substantially flush to the outer shell of the vessel) and substantially perpendicular to the plurality of segmented rings 14 (e.g., forming an approximate 90° angle with the segmented rings). In some embodiments, the “plurality of straps” may be referred to herein as being “vertical” in nature and the “plurality of segmented rings” may be referred to herein as being “horizontal” in nature (although it is to be understood that when the reactor is on its side, such terms are not to be indicative of overall configuration and, rather, are used largely in reference to the direction of the longitudinal axis or length of the reactor, e.g., “vertical” generally refers to the direction along the length of the outer shell of the vessel, which is typically vertical while in use).

The mechanism for connecting or attaching the plurality of segmented rings to the plurality of straps may vary and generally may include any mechanism configured to maintain a secure connection or attachment between the plurality of straps and the plurality of segmented rings. For example, FIG. 4 illustrates the physical connection or attachment of the plurality of straps and the plurality of segmented rings according to one embodiment of the disclosure. As shown in FIG. 4, one of the plurality of segmented rings 14 (a cross-sectional view of one of the segmented rings is depicted in FIG. 4) may be attached to one of the plurality of straps 12 (which are substantially parallel to the outer shell 6 and substantially perpendicular to the segmented rings 14) via at least two curved metal plates 34 and at least one rivet 36 per plate. While the plurality of straps and the plurality of segmented rings are shown as being substantially perpendicular in the depicted embodiments, it should be noted that such a configuration is not required. For example, in some embodiments one or more of the segmented rings and the plurality of straps may form an angle that is less than about 90° or greater than about 90°. In some embodiments, the plurality of segmented rings may be connected or attached to the plurality of straps via various methods (e.g., such as welding, that does not contact the outer shell of the reactor vessel, or some alternative clamping mechanism) so long as the connection or attachment therebetween is sufficient to connect the rings and straps and support the weight of the insulation material.

FIG. 5 illustrates a reactor vessel insulation system according to an embodiment of the disclosure (e.g., including a floating ring 10, a plurality of straps 12, and a plurality of segmented rings 14) that has been installed on a reactor vessel 2 including a first layer of insulation material 18 and a skirt portion 36 attached to a base 38 of the reactor vessel 2. The skirt portion 36 (where present) may comprise various materials, e.g., such as a metal, metal alloy, and the like. In some embodiments, the skirt portion may comprise the same material as the reactor vessel and/or may comprise one or more different materials. In some embodiments, the skirt portion may be attached to the base 38 of the reactor vessel 2 such that the bottom head of the reactor vessel is covered by the skirt portion. One such embodiment is highlighted by detail C in FIG. 5. As depicted in FIG. 5, the reactor vessel is generally oriented in a vertical configuration once installed and operating and thus, in some embodiments, the skirt portion may be substantially perpendicular to the ground so as to provide a stable base for securing the reactor vessel in place. In some embodiments, for example, the skirt portion may be substantially cylindrical in shape; however, the shape of the skirt portion is not limited thereto. Generally, any type of skirt portion commonly used in the art may be suitable for use as described herein above. In some embodiments, the skirt portion may provide a support function for the reactor vessel and/or may be connected to or may surround a separate base support structure configured to provide foundational support to the reactor vessel. In some embodiments, the skirt portion 36 may comprise a plurality of springs (not pictured) connected to the plurality of straps 12 of the reactor vessel insulation system. In such embodiments, the springs may allow the reactor vessel insulation system to expand and/or contract as necessary during operation of the reactor vessel, e.g., allowing for the expansion and/or contraction of the reactor vessel during operation.

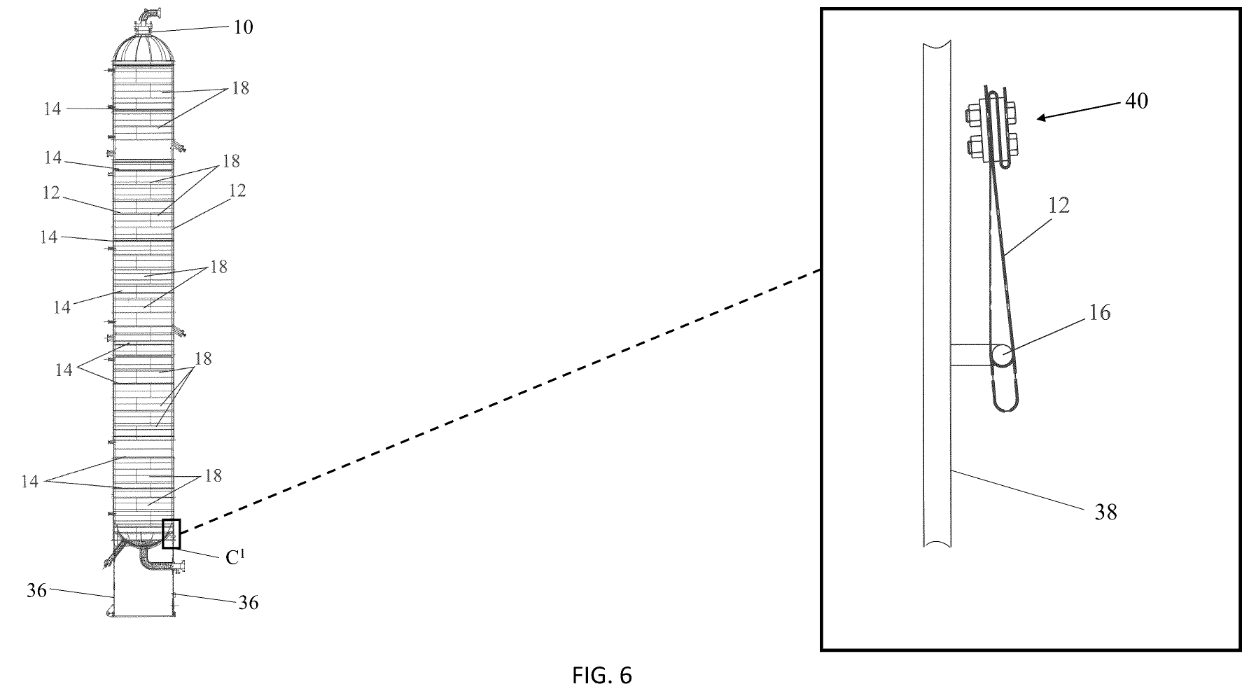

FIG. 6 shows a cut-away view of detail C as shown in FIG. 5, according to another embodiment of the present disclosure (labeled C¹), wherein detail C¹ illustrates a physical connection between one of the plurality of straps 12 and a flange 16 attached to the base portion 38 of the reactor vessel. In some embodiments, the plurality of straps 12 may be connected to the flange 16 via a clamping mechanism 40, for example, which may be the same type of clamping mechanism as described herein above with regard to the connection or attachment between the plurality of straps 12 and the floating ring 10 (see, e.g., FIG. 3). In some embodiments, a plurality of springs (not pictured) may be disposed between one of the plurality of straps 12 and the flange 16 to allow the vessel insulation system to expand and/or contract as necessary during operation of the vessel. In some embodiments, a skirt portion 36 may be connected or attached between the base 38 of the vessel and the ground, as noted above. It should be noted that the mechanism for connecting or attaching the plurality of straps to the base portion of the reactor may vary and generally may include any mechanism configured to maintain a secure connection or attachment between the flange and the plurality of straps during operation of the reactor vessel.

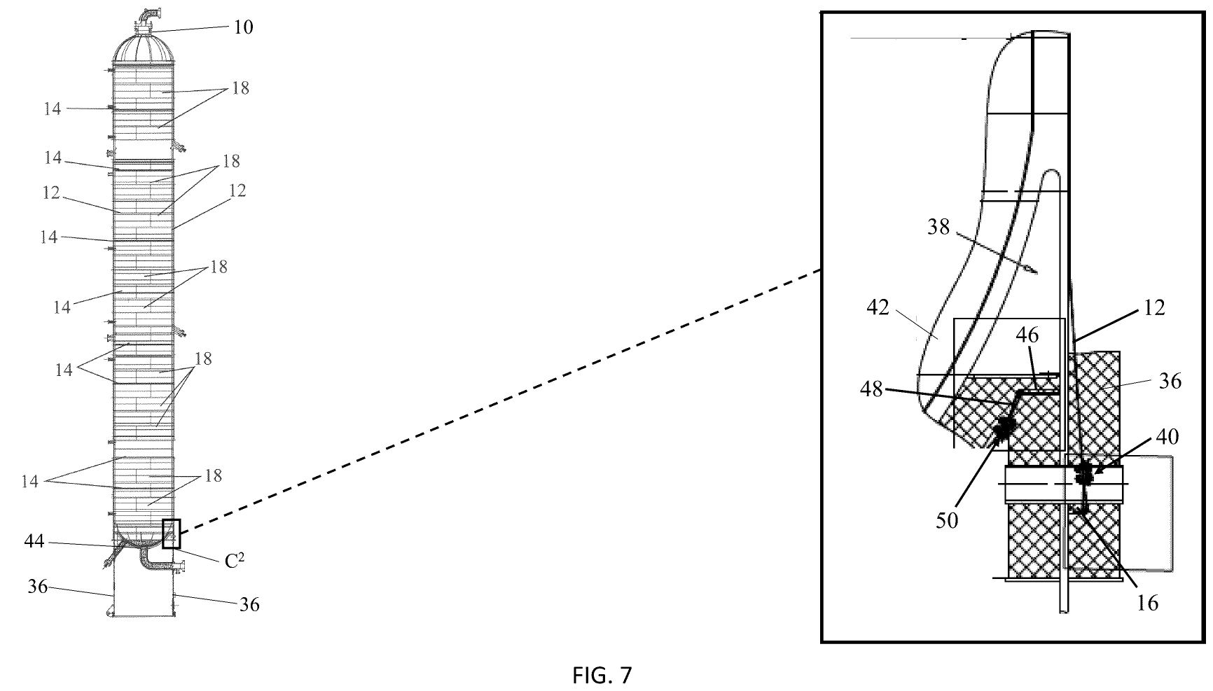

In some embodiments, reactor vessel insulation systems of the disclosure may comprise a second floating ring positioned proximate to a bottom head (e.g., commonly a hemispherical head) 42 of the reactor vessel and circumscribing a bottom component (e.g., a bottom nozzle 44) of the reactor vessel. In such embodiments, it should be noted that the second floating ring generally functions in a similar manner as floating ring 10 described herein above, with respect to FIG. 2 (e.g., comprising a second floating ring, a second plurality of straps, and at least one segmented ring), with exception to the fact that the second plurality of straps do not extend upward along the length of the outer shell of the reactor vessel but instead are only present on the bottom hemispherical head 42 of the reactor vessel. Generally, such a configuration provides support for one or more insulation materials installed proximate to the bottom head 42 of the reactor vessel. FIG. 7 shows a cut-away view, labelled C², according to another embodiment where the reactor vessel insulation system further comprises a second floating ring (not pictured) positioned proximate to the bottom hemispherical head 42 of the reactor vessel and circumscribing a bottom nozzle 44 of the reactor vessel. In the embodiment depicted in FIG. 7, cut-away view labeled C² illustrates the bottom connection of the plurality of straps 12, the connection of one of the second plurality of straps 48, and part of the skirt portion 36 attached to the base portion 38 of the reactor vessel. FIG. 7 depicts the physical connection between one of the plurality of straps 12 and the flange 16 (e.g., via clamping mechanism 40), the flange 16 being connected or attached to the base portion 38 of the reactor vessel, and the physical connection between one of a second plurality of straps 48 and a second flange 46 (e.g., via clamping mechanism 50) the second flange 46 being connected or attached to the base portion 38 of the reactor vessel. It should be noted that, in the depicted embodiment, the strap labeled 48 represents just one of a second plurality of straps 48 that connect or attach to the second floating ring circumscribing the bottom nozzle 44.

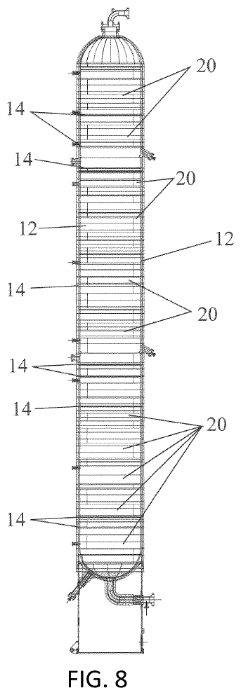

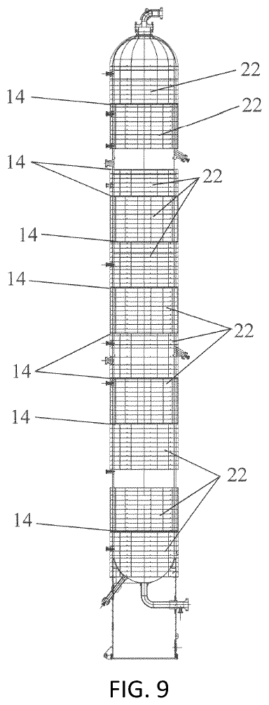

FIG. 8 illustrates a reactor vessel insulation system according to an embodiment of the disclosure (e.g., including a floating ring 10, a plurality of straps 12, and a plurality of segmented rings 14) that has been installed on a reactor vessel including a first layer of insulation material (not pictured) and a second layer of insulation material 20 surrounding the first layer of insulation material and circumscribing the reactor vessel. Generally, the types of insulation material used may be varied as desired and any insulation material as discussed herein above may be suitable for use in such embodiments. In some embodiments, the reactor vessel insulation system may include an outer jacket 22 (as depicted in FIG. 9), wherein the outer jacket 22 surrounds the first layer of insulation material 18 and the second layer of insulation material 20.

An “outer jacket” as used herein, refers to an outer covering that is wrapped around one or more insulation layers thereby surrounding the one or more insulation layers and circumscribing the reactor vessel to shield the insulation from external forces (e.g., moisture, wear, and mechanical damage). In some embodiments, the outer jacket may comprise a corrugated metal jacketing material and a plurality of springs. In some embodiments, the outer jacket may comprise a corrugated metal material, e.g., such as aluminum, stainless steel, zinc galvanized steel, polyvinyl chloride (PVC), fiberglass cloth and/or fabric materials, combinations thereof, and the like. Generally, the types of material used for the outer jacket may vary and may be selected based on mechanical, chemical, thermal, and/or moisture properties as well as based on the cost and desired aesthetics for the installation. In some embodiments, the outer jacket may comprise a plurality of springs (in addition to a metal “jacket” material). The plurality of springs may be characterized as compression and/or expansion springs, which allow for compression and/or expansion of the reactor vessel, the reactor vessel insulation system, and/or the one or more layers of insulation during operation of the reactor vessel. Such springs are generally constructed of metal.

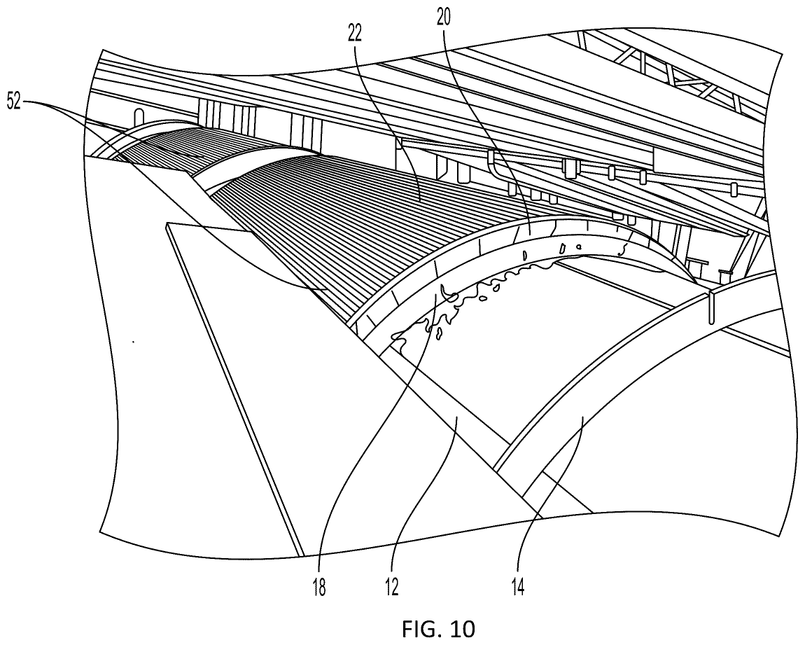

In some embodiments, the insulation material (e.g., including the first layer of insulation material 18 and the second layer of insulation material 20) and/or the outer jacket 20 may comprise a plurality of insulation segments 48, each insulation segment being individually supported by a corresponding segment of the plurality of segmented rings 14. FIG. 10 depicts a close up cross-sectional view of a first layer of insulation material 18, a second layer of insulation material 20, and an outer jacket 22 surrounding the first and second layers of insulation material, each being supported by one of the plurality of segmented rings 14 of the reactor vessel insulation system. Generally, as noted herein above, the weight of the plurality of segmented rings is supported by the plurality of straps attached to the floating ring and the weight of the insulation materials and the outer jacket is supported by the plurality of segmented rings. It should be noted that the number of individual insulation segments 52 may vary based on the type of insulation used, the type of outer jacket, the number of vertical straps, the number of segmented horizontal rings, the number of segments in each horizontal ring, the number of outlet and/or inlet valves on the exterior of the reactor vessel, the size of the reactor vessel, and various other parameters. In some embodiments, for example, the number of individual insulation segments may be at least 4 individual segments, at least 8 individual segments, at least 16 individual segments, at least 32 individual segments, or more (e.g., about 4 to about 50 individual segments, such as about 8 to about 32 individual segments).

In general, it should be noted that the individual insulation segments 52 may be defined by the area between two of the plurality of straps 12 (e.g., which are adjacent to one another) and two of the plurality of segmented rings 14 (e.g., which are adjacent to one another), so as to form a four-sided rectangular shape in embodiments wherein the “vertical” straps and the “horizontal” rings are substantially perpendicular to one another). Such a configuration is not intended to be limiting, and in some embodiments, the individual insulation segments may be defined by one or more other shapes and/or may be irregularly shaped and/or may not be sized in accordance with the embodiments above. In some embodiments, each individual insulation segment may be independently, sized or shaped, based on the specifications of the reactor vessel.

The plurality of insulation segments 52 may advantageously be installed individually (e.g., one segment at a time) to allow for an easier, piece-by-piece installation process. In some embodiments, each insulation segment may be configured to be individually removable and/or replaceable for the purposes of maintenance and repair of the reactor vessel and/or maintenance and repair of the insulation material. In such embodiments, each insulation segment may advantageously be removed and repaired, without disturbing any of the remaining insulation segments. Generally, this ability to remove and repair individual insulation segments is a significant advantage over traditional insulation securement systems, because it can provide increased maintenance efficiency and cost reduction. Such cost reduction may be achieved by maintaining the integrity of the insulation material and the outer jacket material over time, for example, by replacing the typical wear and tear of such materials.

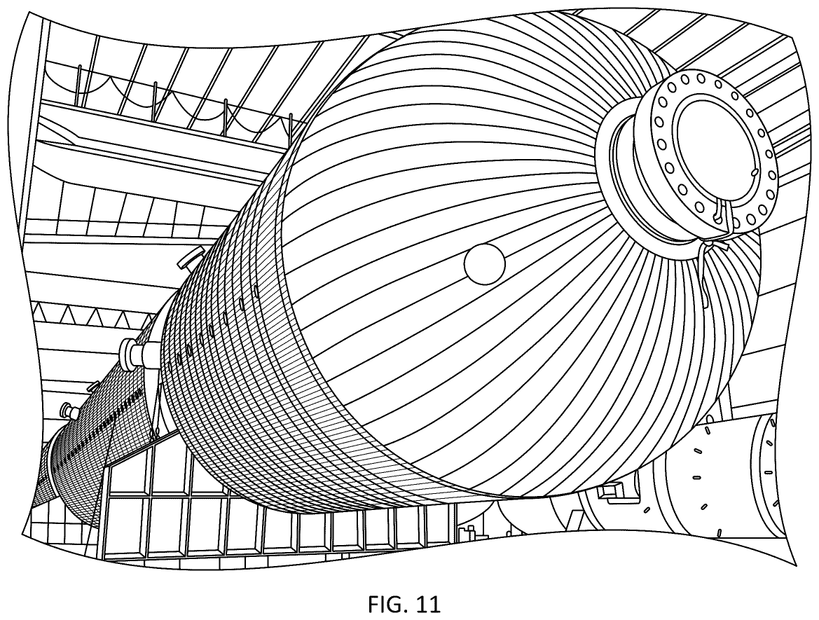

FIG. 11 illustrates a perspective view of the horizontally-positioned reactor vessel and the reactor vessel insulation system of the embodiment as depicted in FIG. 1 in a fully assembled configuration prior to transportation of the reactor vessel insulation system to the operation site. As shown, the reactor vessel and the reactor vessel insulation system have been completely encased by one or more layers of insulation material and an outer jacket.

The disclosure, in addition to providing insulation securement systems and reactor vessels insulated via such systems, provides corresponding methods of insulating a reactor vessel. In some embodiments, a method of insulating a vessel includes installing a reactor vessel insulation system according to an embodiment of the disclosure, and installing one or more layers of an insulation material circumscribing an outer shell of the reactor vessel. In some embodiments, the disclosure provides a method that includes providing a reactor vessel, associating a reactor vessel insulation system therewith, and installing one or more layers of an insulation material circumscribing an outer shell of the reactor vessel. In some embodiments, the method may further include installing an outer jacket surrounding the one or more layers of insulation material, e.g., an outer jacket as described herein above. As noted above, the one or more layers of insulation material and/or the outer jacket may be installed in individual insulation segments. In such embodiments, the methods disclosed herein provide that each insulation segment can be configured to be individually removable and/or replaceable, without disturbing any of the remaining insulation segments.

Advantageously, the disclosed systems and methods can provide, in some embodiments, for insulating a reactor vessel without welding any insulation support structure to the reactor vessel, e.g., such that post-weld heat treatment of the reactor vessel (following any PWHT associated with construction of the outer shell of the vessel itself) is not required. “Insulation support structure” as used herein refers to any structure, or component of that structure, used to support the weight of one or more insulation materials installed on a reactor vessel as described herein (e.g., such as a vessel insulation system as described herein, or any component thereof, including, but not limited to a floating ring, a plurality of straps, a plurality of segmented rings, a skirt portion, and the like). In one or more embodiments, such methods include positioning a floating ring on or near a top component of the vessel (e.g., proximate to and circumscribing a top nozzle of the vessel); attaching a plurality of straps to the floating ring extending downward from the floating ring a length along an outer shell of the vessel; selectively positioning a plurality of segmented rings along the length of the outer shell of vessel, wherein the segmented rings are attached to and supported by the plurality of straps; and installing an insulation material that circumscribes the outer shell of the vessel, the insulation material being supported by the segmented rings. In some embodiments, the method may further include installing the insulation material in individual insulation segments. Although the method for installing insulation and the securement system are described as sequential, the method steps can be conducted in varying order. Thus, in some embodiments, the plurality of straps can be attached to the floating ring prior to the positioning of the floating ring around the top nozzle. In some embodiments, one or more of the plurality of segmented rings may be connected or attached to the plurality of straps prior to connecting or attaching the plurality of straps to the floating ring.

As noted above, typical methods for insulating reactor vessel typically require post-weld heat treatment of the reactor vessel because support brackets commonly used must be welded to the exterior of the reactor vessel in order to support the weight of the insulation materials installed thereon. Such typical methods are generally not cost effective and can damage the integrity of the reactor vessel due to the amount of additional stress applied to the reactor vessel. By contrast, the insulation methods provided according to the disclosure herein alleviate this post-weld heat treatment process. Thus, in some embodiments, none of the above method steps include welding any material to the outer shell of the vessel. Instead, as noted above, the floating ring and the plurality of straps support the plurality of segmented rings forming the reactor vessel insulation system, and generally the weight of the insulation materials and the outer jacket are entirely supported by the reactor vessel insulation system provided herein.

Some aspects of the disclosure relate specifically to a method of maintenance and repair of an insulated reactor vessel. In one or more embodiments, a method of maintaining and repairing an insulate vessel includes providing a reactor vessel and a reactor vessel insulation system according to an embodiment of the disclosure, and selectively removing and replacing individual insulation segments based on a pre-determined level of deterioration and without disturbing any of the remaining insulation segments. The pre-determined level of deterioration may be based at least in part on an amount of deterioration that is expected before the next turnaround or maintenance period for the vessel.

This application is a continuation of U.S. Non-Provisional application Ser. No. 16/828,723, filed Mar. 24, 2020, titled “INSULATION SECUREMENT SYSTEM AND ASSOCIATED METHODS,” which claims priority to and the benefit of U.S. Provisional Application No. 62/823,156, filed Mar. 25, 2019, titled “FLOATING RING VESSEL INSULATION SUSPENSION METHOD AND APPARATUS,” the disclosures of which are incorporated herein by reference in their entireties.

Having the benefit of the teachings presented in the foregoing descriptions, many modifications and other embodiments of the disclosure set forth herein will come to mind to those skilled in the art to which these disclosures pertain. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A vessel insulation system, the system comprising:
a floating ring to circumscribe a nozzle of a vessel;
one or more straps connected to the floating ring, the one or more straps extending from the floating ring and positioned to run along a selected length of an outer surface of the vessel; and
one or more segmented rings connected to the one or more straps and positioned along the selected length of the outer surface of the vessel, each of the one or more segmented rings configured to support an insulation material when positioned along the selected length of the outer surface of the vessel.

2. The vessel insulation system of claim 1, wherein the floating ring, the one or more straps, and the one or more segmented rings each comprises a material selected from the group consisting of metals, metal alloys, or any combination thereof.

3. The vessel insulation system of claim 2, wherein one or more the floating ring, the one or more straps, and the one or more segmented rings comprises a stainless steel material.

4. The vessel insulation system of claim 1, wherein the one or more straps is positioned substantially perpendicular to a portion of the one or more segmented rings.

5. The vessel insulation system of claim 1, wherein the one or more segmented rings is supported by the one or more straps.

6. An insulated marine vessel comprising:
a marine vessel;
a marine vessel insulation system comprising:
a floating ring sized to circumscribe a nozzle of the vessel,
one or more straps connected to the floating ring, the one or more straps extending from the floating ring and positioned to run along a selected length of an outer surface the marine vessel, and
one or more segmented rings connected to the one or more straps and positioned to along the selected length of the outer surface of the marine vessel; and
an insulation material comprising one or more insulation segments, each insulation segment individually and vertically supported by the ledge of a corresponding segment of the one or more segmented rings.

7. The insulated vessel of claim 6, wherein each insulation segment is configured to be removable or replaceable, without disturbing any remaining insulation segments when being removed or replaced.

8. The insulated vessel of claim 7, wherein the insulation material comprises a first layer of insulation, a second layer of insulation, and an outer jacket surrounding the first and second layers of insulation.

9. The insulated vessel of claim 8, wherein the outer jacket comprises a corrugated metal jacketing material and one or more springs.

10. The insulated vessel of claim 7, further comprising a skirt portion positioned proximate a base portion of the marine vessel.

11. The insulated vessel of claim 10, wherein the skirt portion comprises one or more springs connected to the one or more straps, and wherein the one or more springs is configured to allow for expansion of the vessel insulation system during operation.

12. A vessel insulation system comprising:
a floating ring sized to circumscribe a nozzle of a vessel;
one or more straps connected to the floating ring, the one or more straps extending from the floating ring and positioned to run along a selected length of an outer surface of the vessel; and
one or more segmented rings connected to the one or more straps and positioned along the selected length of the outer surface of the vessel, each of the one or more segmented rings having a support surface to support a weight of a segment of insulation material when positioned thereon and along the outer surface.

13. The vessel insulation system of claim 12, wherein the support surface extends outward from the outer shell of the vessel.

14. The vessel insulation system of claim 13, wherein the support surface of each of the one or more segmented rings is positioned substantially perpendicular to the one or more straps.

15. The vessel insulation system of claim 13, wherein the support surface of each of the one or more segmented rings further is positioned to extend outwardly from the outer surface relative to a longitudinal axis of the vessel.

16. The vessel insulation system of claim 12, wherein each of the one or more segmented rings is fastened to one or more of the one or more straps via one or more curved plates.

17. The vessel insulation system of claim 12, wherein the one or more segmented rings is suspended by the one or more straps.
